(19) United States
(12) Patent Application Publication
(10) Pub. No.: US 2014/0126698 A1
(43) Pub. Date: May 8, 2014

(54) GENERATION OF MULTIPLE ENERGY X-RAY RADIATION

(71) Applicant: Rolf Karl Otto Behling, Eindhoven (NL)

(72) Inventor: Rolf Karl Otto Behling, Eindhoven (NL)

(73) Assignee: KONINKLIJKE PHILIPS N.V., EINDHOVEN (NL)

(21) Appl. No.: 14/127,529

(22) PCT Filed: Jun. 4, 2012
(86) PCT No.: PCT/IB2012/052799

§ 371 Date: Dec. 19, 2013

(30) Foreign Application Priority Data
Jun. 30, 2011 (EP) 11172056.1

(51) Int. Cl. H01J 35/10

(52) U.S. Cl. CPC H01J 35/101
USPC 378/62; 378/135

(57) ABSTRACT

The present invention relates to the generation of multiple energy X-ray radiation. In order to provide multiple energy X-ray radiation with increased switching frequencies, a rotating anode (10) for an X-ray tube is provided with an anode body (12), a circular focal track (14), and an axis of rotation (16). The focal track is provided on the anode body and comprises at least one first focal track portion (18) and at least one second focal track portion (20). Transition portions (22) are provided between the at least one first and second focal track portions. The at least one first focal track portion is inclined towards an X-ray radiation projection direction (24) of the X-ray tube. The at least one second focal track portion is divided in a direction (26) transverse to the radial direction and comprises a primary sub-portion (28), which is inclined towards the X-ray radiation projection direction, and a secondary sub-portion (30), which faces less towards the X-ray radiation projection direction than the primary sub-portion. The transition portions are provided such that a direction of X-ray radiation generated at the surface of the transition portions is different than the X-ray radiation projection direction.

### FIELD OF THE INVENTION

The present invention relates to the generation of multiple energy X-ray radiation. The present invention in particular relates to a rotating anode, an X-ray tube for generating multiple energy X-ray radiation, a system for X-ray imaging, a method for generating multiple energy X-ray radiation, as well as a computer program element and a computer readable medium.

### BACKGROUND OF THE INVENTION

Multiple energy X-ray radiation is used, for example, in dual energy image acquisition in medical imaging. For example, a first X-ray radiation characteristic is provided by applying a first tube voltage, and a second characteristic of X-ray radiation is provided by applying a second tube voltage. Further, movable filters can be placed in front of the X-ray tube for filtering or non-filtering of the X-ray beam to generate dual energy X-ray radiation. In order to improve resolution and thus image quality, faster switching is used. However, faster switching means increasing mechanical loads for a movable filter. WO 2008/072175 A1 describes an X-ray source generating X-radiation with an energy spectrum which varies continuously, wherein a rotating filter disk is provided.

### SUMMARY OF THE INVENTION

Thus, there is a need to provide multiple spectra X-ray radiation with improved switching frequencies.

The object of the present invention is solved by the subject-matter of the independent claims, wherein further embodiments are incorporated in the dependent claims.

It should be noted that the following described aspects of the invention apply also for the rotating anode, the X-ray tube for generating multiple energy X-ray radiation, the system for X-ray imaging, the method for generating multiple energy X-ray radiation, as well as for the computer program element and the computer readable medium.

According to a first aspect of the present invention, a rotating anode for an X-ray tube is provided, comprising an anode body, a circular focal track, and an axis of rotation. The focal track is provided on the anode body and comprises at least one first focal track portion and at least one second focal track portion. Further, transition portions are provided between the at least one first and second focal track portions. The at least one first focal track portion is inclined towards an X-ray radiation projection direction of the X-ray tube. The at least one second focal track portion is divided in a direction transverse to the radial direction and comprises a primary sub-portion, which is inclined towards the X-ray radiation projection direction, and a secondary sub-portion, which faces less towards the X-ray radiation projection direction than the primary sub-portion. The transition portions are provided such that a direction of X-ray radiation generated at the surface of the transition portions is different from the X-ray radiation projection direction.

The term “X-ray radiation projection direction” refers to the part of a generated X-ray radiation that is directed towards a detector. The term “X-ray radiation projection direction” may refer to an imaginary centre line of an X-ray beam, i.e. to the main direction of the X-ray beam. The main direction of the X-ray radiation projection direction is directed towards the centre of the detector.

According to an exemplary embodiment of the invention, the X-ray radiation projection direction is perpendicular to the axis of rotation. The at least one first focal track portion is inclined such that it faces away from the axis of rotation. The primary sub-portion is inclined such that it faces away from the axis of rotation. The secondary sub-portion is inclined such that it faces towards the axis of rotation. The transition portions are facing towards the axis of rotation or are parallel to the axis of rotation and are arranged such that the surface is shielded from the X-ray radiation projection direction.

The term “perpendicular to the axis of rotation” of the X-ray beam refers to an imaginary centre line of the beam and comprises also directions which are not in 90 degrees but in smaller or larger angle, for example an angle range of approximately 30 degrees to 150 degrees.

According to a further exemplary embodiment, the transition portions are provided with side edges adjacent to the first and second focal track portions, wherein the side edges are tapered in direction away from the axis of rotation.

According to a further exemplary embodiment of the invention, an X-ray filter with at least one X-ray filter segment is provided outside the primary sub-portion of the at least one second focal track portion, which filter segment is attached to the anode.

According to a further exemplary embodiment, the filter has a varying X-ray filter characteristic over its circumferential extension.

According to a second aspect of the present invention, an X-ray tube for generating multiple energy X-ray radiation is provided, comprising a cathode, an anode and a housing. An electron beam can be emitted from the cathode towards the anode. The cathode and the anode are arranged inside the housing. An X-ray window is provided in the housing. The anode is provided according to one of the above-mentioned aspects and exemplary embodiments.

According to a third aspect of the present invention, a system for X-ray imaging is provided, comprising an X-ray source, an X-ray detector, and a control unit. The X-ray source comprises an X-ray tube according to the above-mentioned aspect of the present invention.

According to a fourth aspect of the present invention, a method for generating multiple energy X-ray radiation is provided, comprising the following steps:

a) providing an electron beam to a first focal track portion of a rotating anode, which first focal track portion is inclined towards an X-ray radiation projection direction of the X-ray tube;
b) generating a first X-ray beam with first X-ray characteristic;
c) providing the electron beam to a transition portion between the first focal track portion and a second focal track portion, which transition portion is provided such that a direction of X-ray radiation generated at the surface of the transition portions is different than the X-ray radiation projection direction;
d) providing the electron beam to the second focal track portion of the rotating anode, which second focal track portion is divided in a direction transverse to the radial direction and comprises a primary sub-portion, which is inclined towards the X-ray radiation projection direction, and a secondary sub-portion, which faces less towards the X-ray radiation projection direction than the primary sub-portion; and
e) generating a second X-ray beam with second X-ray characteristic.

According to an exemplary embodiment of the present invention, the second X-ray beam is filtered by an X-ray filter provided outside the primary sub-portion, which filter segment is attached to the anode.

According to a further exemplary embodiment, the electron beam impinging on the second focal track portion is generated with a higher tube voltage than an electron beam impinging on the first focal track portion.

According to an aspect of the present invention, the focal track is provided with different geometries such that different parts of the electron beam generate different sub-portions of X-ray radiation. By providing the secondary sub-portions such that they face less towards the X-ray radiation projection direction, the X-ray radiation generated at these secondary sub-portions is radiated in a direction different to the X-ray radiation projection direction. In other words, at least a part of the generated X-rays is not provided to be used for X-ray imaging purposes, for example.

According to another aspect, the transition portions provide an improved transit between the two energies, i.e. a shortened transit. The focal spot is virtually shortened by placing its “inner part” behind an edge, which also means a partial beam dump, where X-rays are partially not used, as long as a filter on the anode passes it at very close distance, which state can also be referred to as filter “on”. By placing the “inner part” in the beam dump, the focal spot is shortened in radial direction, and the transition period, where only a sub-set of detector elements would be illuminated by the filtered X-ray beam, and the other sub-set of the detector elements would be illuminated by the less filtered X-ray beam, is shortened. Additional to shortening the transition period, the used X-ray beam is totally blanked out during transition: During the transition, the entire electron beam is dumped and not used for generating X-rays radiating in the X-ray radiation projection direction. Next, the electron beam hits the first focal track portion between the edges of adjacent filter elements, in which state all radiation is used from the first focal track portions, i.e. filter “off”.

According to a further aspect, third or more focal track portions are also provided, which are provided with different X-ray radiation generating characteristics. According to a still further aspect, different voltages are supplied. The voltages can differ among one type of focal track portion, and/or among different types of focal track portions.

These and other aspects of the invention will become apparent from and elucidated with reference to the embodiments described hereinafter.

### BRIEF DESCRIPTION OF THE DRAWINGS

Exemplary embodiments of the invention will be described in the following with reference to the following drawings.

FIG. 1 schematically shows a first embodiment of a rotating anode according to the invention in a plan view.

FIGS. 2A to 2C show a further exemplary embodiment of a rotating anode according to the present invention in a cross-sectional view, taken along different lines.

FIGS. 3A and 3B show a further exemplary embodiment of a rotating anode according to the present invention in a cross-section.

FIGS. 4A and 4B show a plan view of the anode of FIG. 3.

FIGS. 5A and 5B show a further exemplary embodiment of a rotating anode according to the present invention in a perspective view.

FIG. 6 shows a plan view of a further example for a rotating anode according to the present invention.

FIG. 7 shows a perspective view of the rotating anode of FIG. 6.

FIG. 8 shows a straightened view of a focal spot track of a further exemplary embodiment of a rotating anode according to the present invention.

FIG. 9 shows a section of a further example of a focal spot track according to the present invention.

FIG. 10 shows a further exemplary embodiment of a rotating anode according to the present invention.

FIG. 11 shows a further example of a rotating anode according to the present invention.

FIG. 12 shows timing aspects of a further example of the present invention.

FIG. 13 shows spectra and photon flux according to a further exemplary embodiment according to the present invention.

FIG. 14 shows a further example of a rotating anode according to the present invention in a plan view.

FIG. 15 shows a further exemplary embodiment of a rotating anode according to the present invention in a cross-sectional view and a plan view.

FIGS. 16 and 17 show further aspects of the example of FIG. 15.

FIG. 18 shows a further example of a rotating anode according to the present invention.

FIG. 19 shows a further exemplary embodiment of a rotating anode according to the present invention.

FIG. 20 shows an exemplary embodiment of an X-ray tube according to the present invention.

FIG. 21 shows an exemplary embodiment of a system for X-ray imaging according to the present invention.

FIG. 22 shows basic method steps of an exemplary embodiment of a method for generating multiple energy X-ray radiation according to the present invention.

FIGS. 23 and 24 show further examples of a method according to the present invention.

### DETAILED DESCRIPTION OF EMBODIMENTS

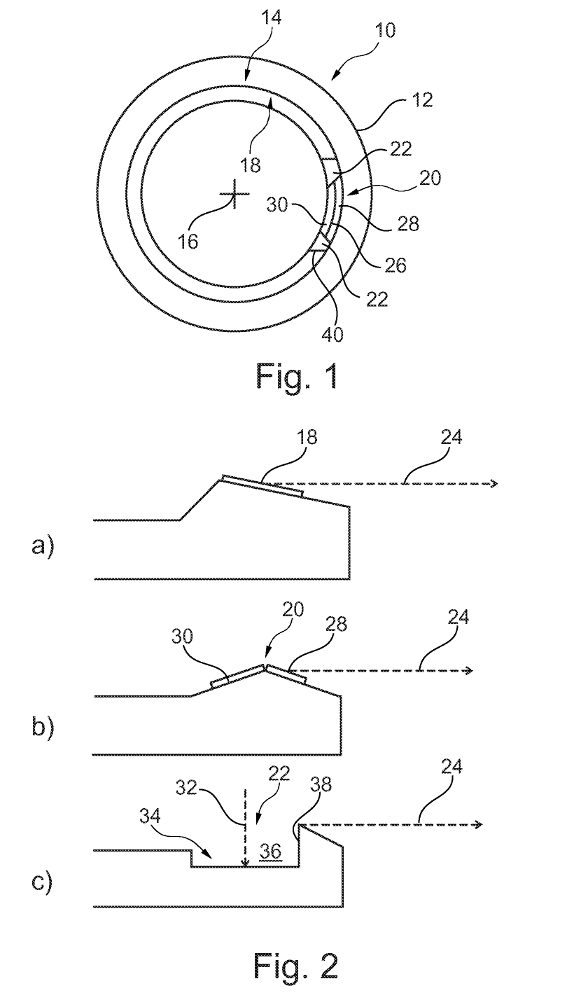

FIG. 1 shows a rotating anode for an X-ray tube, comprising an anode body 12, a circular focal track 14, and an axis of rotation 16, indicated with a cross mark only.

The focal track is provided on the anode body and comprises at least one first focal track portion 18 and at least one second focal track portion 20. Further, transition portions 22 are provided between the at least one first focal track portion 18 and the second focal track portion 20.

FIG. 2A shows a cross-section through the first focal track portion 18; FIG. 2B shows a cross-section through the second focal track portion 20; and FIG. 2C shows a cross-section through one of the transition portions 22.

The first focal track portion 18 is inclined towards an X-ray radiation projection direction, indicated with a dotted arrow 24 in FIG. 2.

The second focal track portion 20 is divided in a direction transverse to the radial direction, as indicated with line 26 in FIG. 1, and comprises a primary sub-portion 28, which is inclined towards the X-ray radiation projection direction 24, and a secondary sub-portion 30, which faces less towards the X-ray radiation projection direction 24 than the primary sub-portion 28. As shown in FIG. 2B, the secondary sub-portion 30 rather faces in an opposite direction than the X-ray radiation projection direction 24. It is noted that the secondary sub-portion can also be provided in a different arrangement, as long as the resulting X-ray radiation is not projected in the X-ray radiation projection direction 24.

The transition portions are provided such that a direction of X-ray radiation generated at the surface of the transition portions is different than the X-ray radiation projection direction.

With reference to FIG. 2C, it is noted that an electron beam, indicated with a dotted arrow 32, impinging on the transition portion 22 would generate X-ray radiation that would have a different direction than the X-ray radiation projection direction 24.

The transition portions 22 may be provided as beam dumps 34, as shown in FIG. 2C.

The transition portions 22 can also be provided as an inclined surface, facing away from the X-ray radiation projection direction 24, such that generated X-ray radiation would not be radiated in the projection direction 24.

It is noted that the X-ray radiation projection direction 24 refers to a range of directions, for example to a fan- or cone-shaped X-ray beam.

The transition portions are provided such that X-ray radiation generated at the surface of the transition portions does not contribute to the X-ray radiation used for projection.

For example, a line-of-sight from the surface of the transition portions to an X-ray window (not further shown in FIG. 1 or 2) or X-ray port, is blocked by X-ray opaque, or X-ray damping, or X-ray absorbing material of the anode.

The X-ray radiation projection direction may comprise a field of used X-ray radiation, or a field of effective X-ray radiation.

Of course, X-ray radiation is generated at the focal spot in a variety of directions. However the term “X-ray” or “X-ray radiation beam” in this context refers to the X-rays radiated through an X-ray window in a housing or envelope of an X-ray tube, for example, X-rays radiated towards a detector.

It is further noted, that instead of a rotating anode, a moving anode can be provided, for example in a pivoting or sliding movement in a back and forth direction.

Instead of a movable anode, a deflection of an X-ray beam may be provided such that the different focal track portions are sequentially, or successively, hit by an electron beam.

It is an aspect of the present invention to provide differently shaped focal tracks such that due to the different shapes, different portions of an X-ray beam are generated and thus radiated in the radiation direction 24.

According to a further exemplary embodiment (not further shown in detail), the X-ray radiation projection direction is perpendicular to the axis of rotation 16. The at least one first focal track portion 18 is inclined such that it faces away from the axis of rotation. The primary sub-portion 28 is inclined such that it faces away from the axis of rotation 16, wherein the secondary sub-portion 30 is inclined such that it faces towards the axis of rotation. The transition portions 22 are facing towards the axis of rotation 16 or are parallel to the axis of rotation and are arranged such that the surface is shielded from the X-ray radiation projection direction 24.

The transition portions may be provided as at least partial recesses in the anode surface, which recesses comprise at least a sidewall in the direction of the X-ray radiation projection direction. This is indicated in FIG. 2C, where the transition portion 22 is provided as a recess 36 with a sidewall portion 38 on the right side, shielding X-ray radiation and thus preventing them from projection in the X-ray radiation projection direction 24.

It is further noted that instead of only one focal track portion 18 as shown in FIG. 1, and only one second focal track portion 20, a plurality of first and second focal track portions 18, 20 can be provided instead, in an alternating manner, wherein a transition portion 22 is provided between a first focal track portion 18 and adjacent second focal track portion 20.

The at least one first focal track portion may be provided to generate a first useful X-ray beam which is used to create an X-ray image. The at least one second focal track portion is provided to generate a second useful X-ray beam. The intensity of the second useful X-ray beam is smaller due to a reduced dimension of the useful part of the focal spot which is used to create an X-ray image and a reduced radial dimension of the focal track on which the useful part of the focal spot is located, while an unused part of the X-rays is emerging from the unused part of the focal spot which is located on the secondary sub-portion, which is facing away from the axis of rotation, of the at least one second focal track portion 20.

The second focal track portion 20 may be divided in a direction substantially perpendicular to the radial direction, as shown in FIG. 1. The second focal track portion 20 may also be divided in a direction in an angular manner to the direction being perpendicular to the radial direction.

The transition portions 22 may be provided with side edges 40 adjacent to the first and second focal track portions 18, 20, wherein the side edges are tapered in a direction away from the axis of rotation 16.

It is noted that the tapered side edges 40 are also shown in relation with FIG. 1, however, the transition portions 22 can also be provided with differently shaped side edges 40.

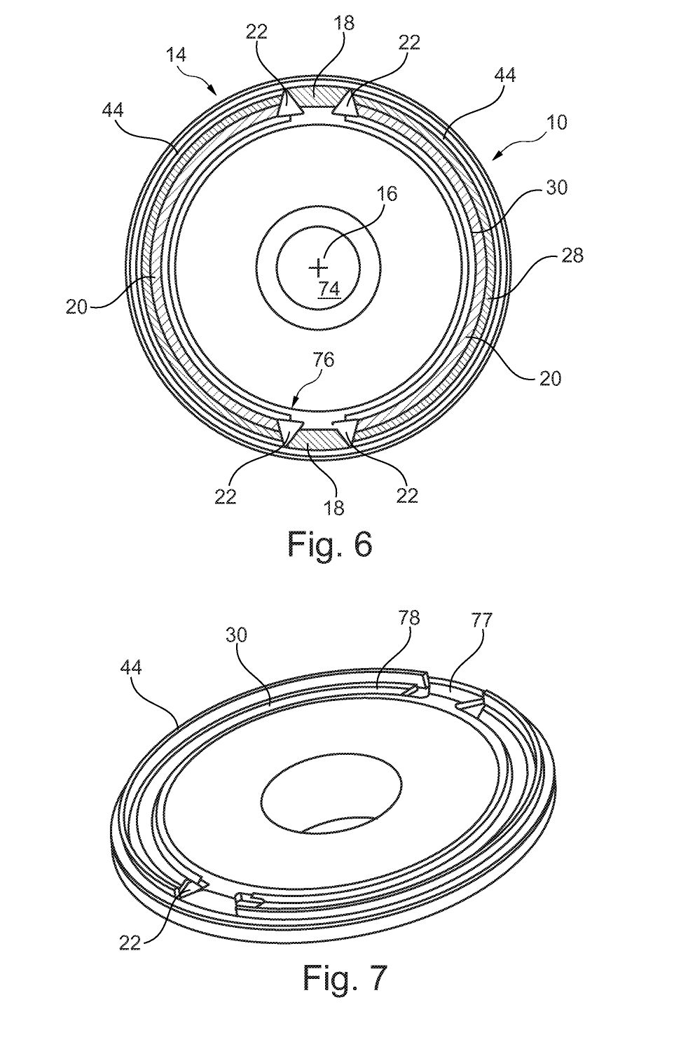

The tapered side portions may be inclined in relation to the radial direction. The tapered side portions may be provided symmetrically with respect to the radial direction, or axis of rotation. For example, the transition portions have a substantially triangular shape (see, for example, FIG. 6).

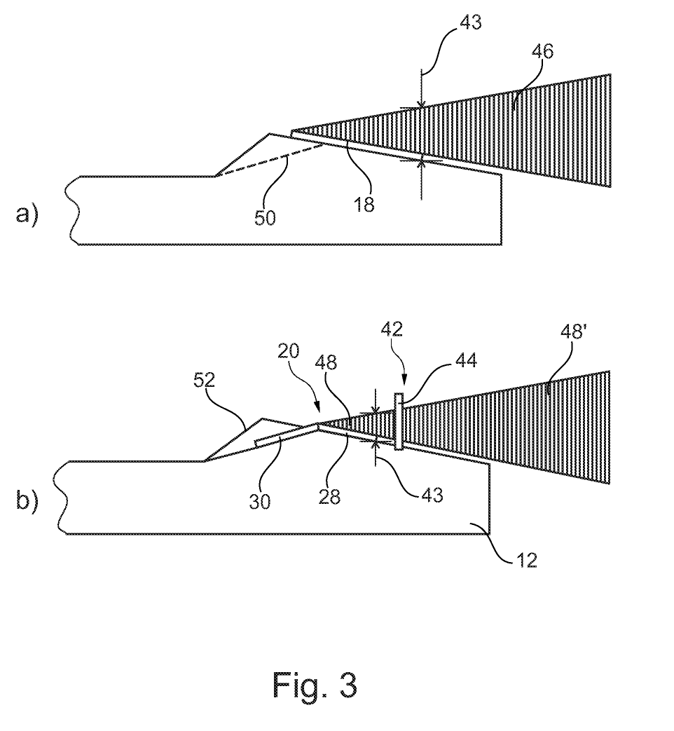

As shown in FIG. 3, an X-ray filter 42 may be provided with at least one X-ray filter segment 44 outside the primary sub-portion 28 of the at least one second focal track portion 20, which filter segment 44 is attached to the anode body 12. As shown in FIG. 3A, the filter is rotated away, i.e. the filter is not in the beam, and all of the focal spot produces used X-rays. Thus, the focal spot has an elongated shape. The electron beam can be provided on a plateau between filter segments. As shown in FIG. 3B, the filter is in the beam, and only part of the focal spot produces used X-rays, thus shortening the optical focal spot. The optical focal spot length is indicated with double arrow 43.

As shown in FIG. 3A, the first focal track portion 18 is used for generating a first X-ray beam 46 which leaves the anode unfiltered. The primary sub-portion 28 of the second focal track portion 20 is used for generating a second X-ray beam 48 which is then filtered by the X-ray filter segment 44. Thus, the second X-ray beam 48 leaves the anode as a filtered second X-ray beam 48′.

It is noted that the necessary electron beam for generating the X-ray radiation is not further shown in FIG. 3.

It is further noted that the secondary sub-portion 30 of the second focal track portion 20 does not contribute to the X-ray beam 48.

For a better understanding, FIG. 3A also shows the shape of the adjacent second focal track portion 20 with a dotted line 50. In a similar manner, FIG. 3B shows the adjacent first focal track portion 18 in its outer shape 52.

The filter may comprise a number of filter segments 44 with different X-ray filter characteristic. The filter may comprise a number of equal X-ray filter segments with equal X-ray filter characteristic (not further shown).

For example, in case of a plurality of second focal track portions, a respective number of filter segments 44 may be provided.

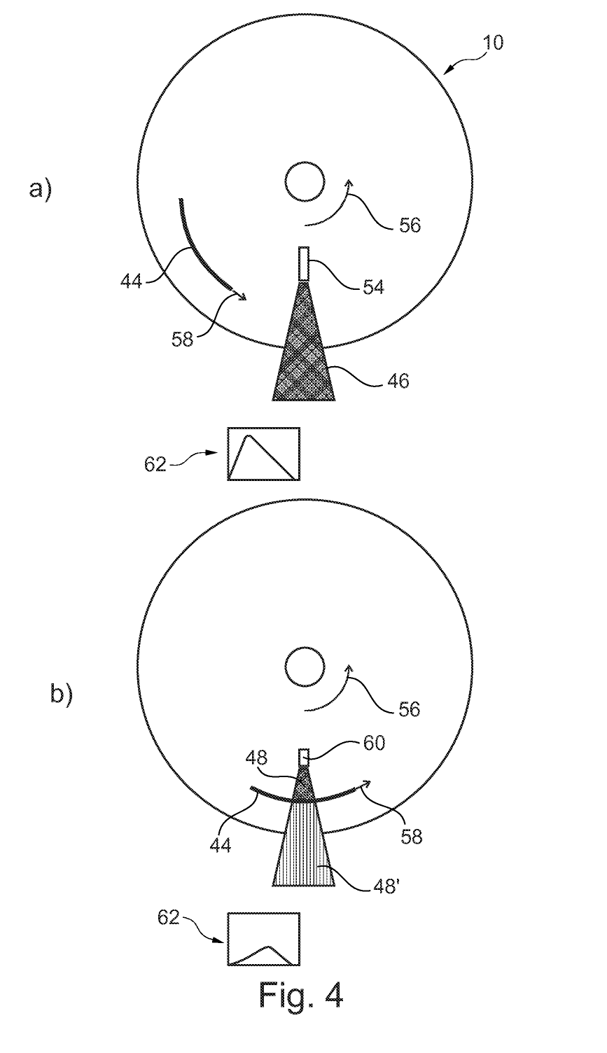

FIG. 4A shows a top view of the anode 10 with one filter segment 44, as an example. Further, the effective focal spot resulting from an electron beam impinging the first focal track portion 18 is indicated with reference numeral 54. Further, the resulting X-ray beam 46 as an unfiltered X-ray beam is also indicated.

A first arrow 56 indicates the rotating direction of the anode 10, and a second arrow 58 indicates the expected movement of the filter segment 44 due to the rotation of the anode.

Upon rotation, the filter segment 44 is brought into a position in front of the focal spot position, which is the primary sub-portion 28, which is indicated as an effective focal spot with reference numeral 60. Further, a first pattern indicates the unfiltered X-ray beam 48, and a second pattern indicates the filtered X-ray beam 48′ after passing the filter segment 44.

A respective minimized graph 62 is shown underneath the respective top view in FIGS. 4A and 4B, indicating the resulting X-ray radiation characteristics of the X-ray beam used for X-ray image projection.

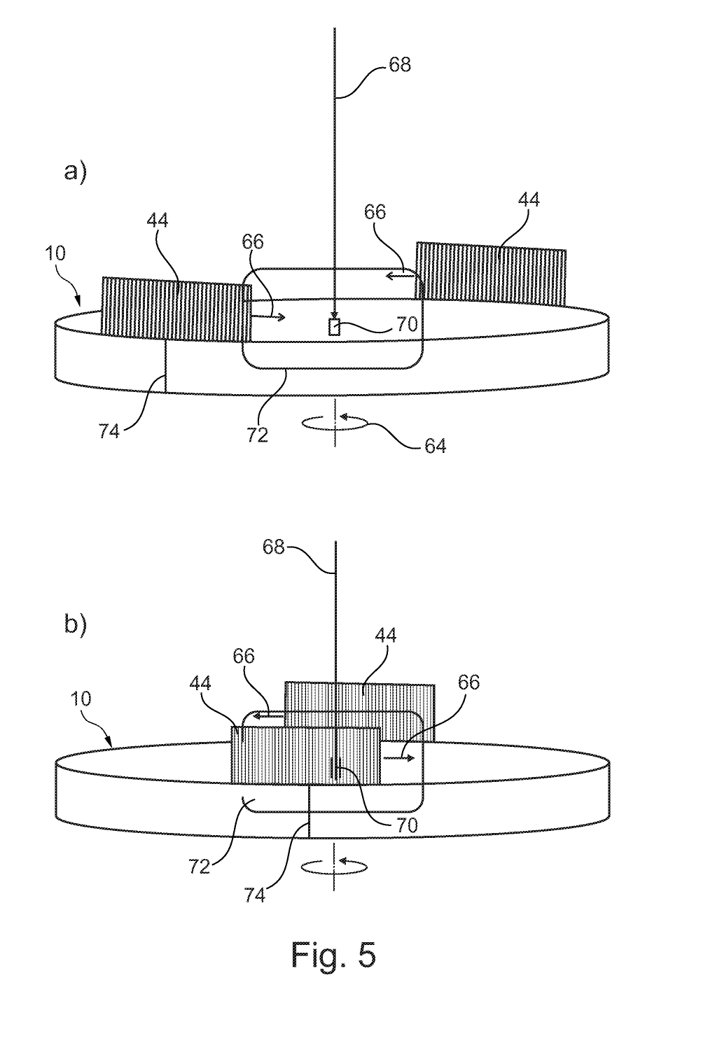

FIGS. 5A and 5B show the rotating anode 10 in a perspective view. A circular arrow 64 indicates the rotation of the anode, and further arrows 66 indicate the movement of the filter segments 44, which are shown as two filter segments as an example in FIG. 5. Further, a thick line 68 indicates an electron beam impinging on the respective focal spot, indicated with reference numeral 70.

Further, a frame 72 indicates an X-ray port or X-ray window.

As can be seen, the filter segments 44 are mounted on the rotating anode 10.

A further aspect is shown in FIG. 5A in that a synchronization mark 74 is provided on the circumferential face of the anode 10.

It is noted that the synchronization mark is not an essential part of the other features shown in FIG. 5A and that the synchronization mark can also be applied to the other exemplary embodiments, described above and described in the following, also.

Upon rotation of the anode disc 10, the left filter segment 44 of FIG. 5A is brought into a position in front of the focal spot 70 such that X-ray radiation generated at the focal spot 70 emanating towards the X-ray port 72 now passes the filter segment 44 before leaving the X-ray port 72 for the projection purposes.

According to a further example, not further shown, the electron beam provided to the focal spot when the electron beam hits the second focal track portion 20 may be provided with a tube voltage of 140 kV. According to a further example, the respective electron beam applied to the first focal track portion 18 may be provided with a lower tube voltage, for example 80 kV or less than 80 kV, for example 40 kV or even 20 kV.

FIG. 6 shows a top view of a further example of an anode according to the present invention. The anode 10 is shown with an opening 74 in the centre of the anode, for example for mounting purposes to a rotation stem, for example. Further, the anode is provided with the above-mentioned circular focal track, comprising two first focal track portions 18 and two second focal track portions 20. As also indicated, the second focal track portions 20 each comprise the above-mentioned primary sub-portion 28 and the secondary sub-portion 30.

Further, between the first and second focal track portions 18, 20, transition portions 22 are provided, which due to the two first focal track portions 18 and the two second focal track portions 20 are provided as four transition portions 22. As can be seen, the transition portions 22 are provided in a triangular shape 76 each.

The anode 10 further comprises two filter segments 44, which each extend over the complete length of the respective second focal track portion 20.

FIG. 7 shows a perspective view of the anode of FIG. 6.

Those surface portions of the focal track which contribute to X-ray radiation used for projection purposes are indicated with a first pattern 77, and those portions of the focal track which do not contribute to the X-ray radiation are shown with a second pattern 78.

Thus, the secondary sub-portions 30, as well as the transition portions 22 act as a beam dump. Further, the perspective view also illustrates the filter segments 44 being provided as filter ring segments.

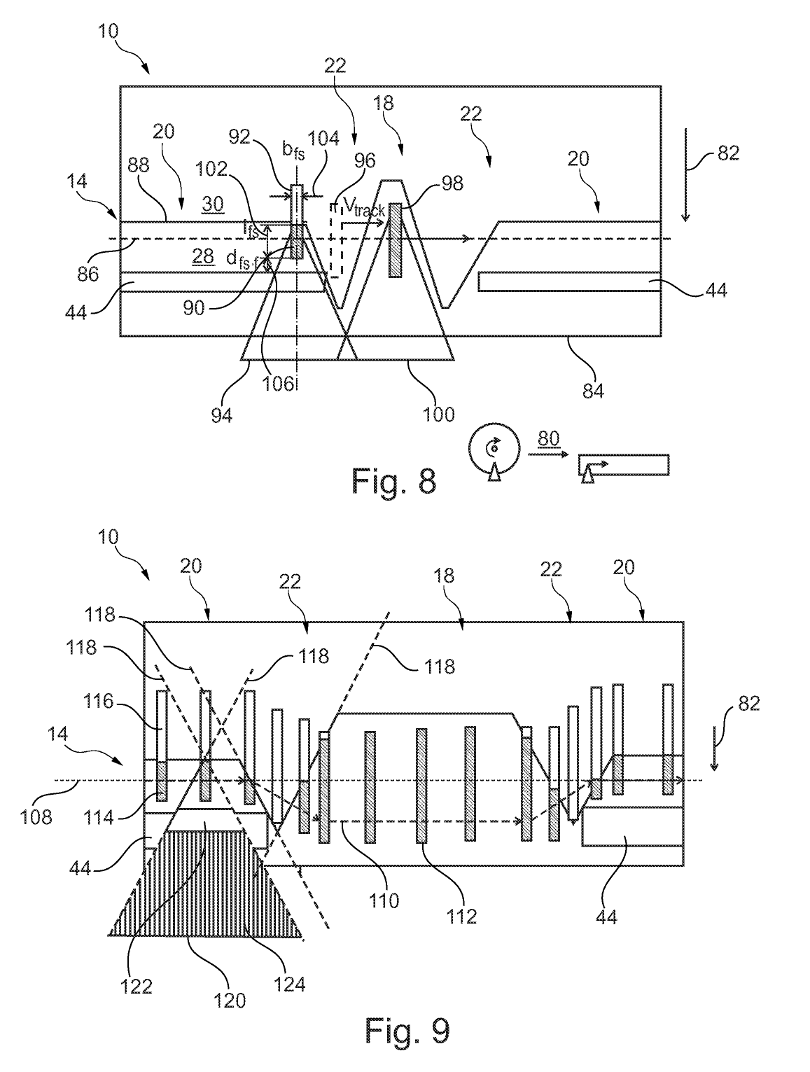

FIG. 8 shows a section of an anode disc according to the present invention in a plan view, wherein for simplicity reasons, the plan view is shown as a straightened view, as schematically indicated with explanation icon 80

FIG. 8 shows a first second focal track portion 20, followed by a first transition portion 22, a first focal track portion 18, a second transition portion 22, and another second focal track portion 20, i.e. a second second focal track portion 20, when viewed from the left to the right. Further, an arrow 82 indicates the direction of the anode radius, i.e. the centre of the rotating anode is above FIG. 8, thus forming an outer edge 84 of the anode at the lower part of FIG. 8.

A first dotted line 86 indicates the relative travel path of the electron beam across the anode, thus forming a circular focal track 14. The above-mentioned division of the second focal track portion into the primary sub-portion 28 and the secondary sub-portion 30 is indicated with line 88.

The resulting effective focal spot is indicated with a first frame 90 filled with a first pattern. The not-used portion of the focal spot, since this portion is provided on the secondary sub-portion 30, is indicated with a first dotted frame 92.

The resulting X-ray beam is indicated with a first fan-shape 94. Further, a first filter segment 44 is shown in relation with the first of the second focal track portions 20 and a further filter segment 44 is shown in relation with the second of the second focal track portions 20. However, the filtering of the X-ray beam 94 is not further indicated in FIG. 8.

Upon rotating of the anode, the focal spot is positioned above the first transition portion 22, resulting in an unused focal spot, as indicated with a second dotted frame 96. Of course, no X-ray beam is generated at this focal spot position.

Upon further rotational movement, the focal spot position is located on the first focal track portion 20, resulting in an effective focal spot being larger than the focal spot being effective in the position on the second focal track portion 20. The effective focal spot on the first focal track portion 18 is indicated with a second frame 98. This leads to a second X-ray beam indicated with a second fan-shape 100. It is noted that the first X-ray beam 94 resulting from the second focal track portion 20 and the second X-ray beam 100 resulting from the first focal track portion 18 have different X-ray characteristics.

Further, a first double arrow 102 indicates the length of the focal spot, and a second double arrow 104 indicates the width of the focal spot. The following equations apply:

$$\begin{matrix}τ = [ ( {1}_{fs} + {d}_{fs - f} ) * 2 * tan ( δ / 2 ) + {b}_{fs} ] / {v}_{track} \\ = [ \begin{matrix}( 1.2 * {1}_{projected \_ fs IEC} / sin ( α ) + {d}_{fs - f} ) * \\ 2 * tan ( ϕ / 2 ) + {b}_{fs}\end{matrix} ] / [ 2 π * {f}_{rotor} * {r}_{track} ] \\ = [ \begin{matrix}( 1.2 * {1}_{projected \_ fs \_ IEC} / sin ( α ) + {d}_{fs - f} ) * \\ 2 * tan ( ϕ / 2 ) + 1 , 2 * {b}_{fs \_ IEC}\end{matrix} ] / [ 2 π * {f}_{rotor} * {r}_{track} ]\end{matrix}$$

Thus, according to the present invention, it is possible to shorten the focal spots for high kV application. Further, the distance of the inner focal spot edge to the filter is minimized to shorten the transition time. The distance is indicated with third double arrow 106.

The anode rotation is used for the relative movement between the different focal track portions.

The focal spot for low kV may be larger than the focal spot for high kV.

Thus, a high photon flux results at low kV.

Further the transition portions 22 provide the dumping of unnecessary parts of the electron beam, which is used for short focal spots and transition times.

For example, a grid switch is not needed.

FIG. 9 shows a further example of a focal spot track, also in a straightened view.

The anode 10 has a circular focal track 14 with a first of second focal track portions 20, followed by a first transition portion 22, a first focal track portion 18, a second transition portion 22, and a second of the second focal track portions 20, when viewed from the left to the right.

A first dotted line 108 indicates the centre line of the focal spot. A second dotted line 110 indicates a path of the electron beam on the anode, generating X-rays.

For each focal spot position, a rectangular frame 112 is shown. The frame 112, depending on the respective location, also indicates the portion of the electron beam being used for the generation of X-ray radiation, as indicated with a first pattern 114, and/or the part of the electron beam not being used for the generation of X-ray radiation, as indicated with a second pattern 116. In other words, the second pattern 116 indicates the dumped part of the electron beam, and the first pattern 114 indicates the X-ray generating part of the electron beam.

Further, filter segments 44 are indicated at the respective second focal track portions 20.

As indicated with further dotted lines 118, the edge of the beam dump, i.e. the edge of the transition portions 22, is parallel to the outer edge of the fan beam, generated at the second focal track portion 20.

It is noted that the X-ray fan beam, indicated with reference numeral 120, is divided into an upper part 122, indicating the unfiltered part, and a lower part 124, indicating the filtered part due to passing the filter segment 44.

With reference to the above-mentioned dotted line 110, indicating the path of the electron beam, it is mentioned that in the area of the first focal track portion 18, an outward deflection during a change of the high voltage and transition into the filter off status is indicated.

The edge of the triangular part of the transition portion (the beam dump) is parallel to the outer edge of the fan beam. So, upon “appearance” from the beam dump, the X-ray beam will always cover the entire fan angle and detector, and no partial shadowing by the filter will occur. The X-ray flux will ramp up, respective down during transition.

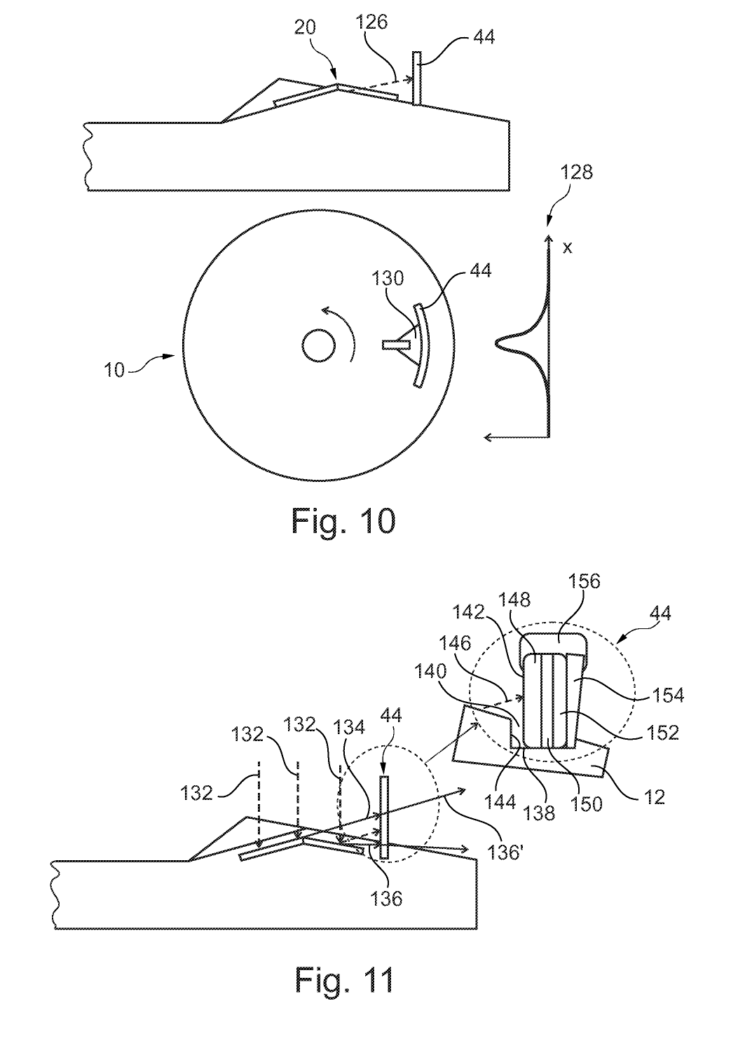

FIG. 10 shows a schematic cross-section through a second focal track portion 20 and a top view below. A dotted line arrow 126 indicates the scattered electrons hitting the filter. Since the filter is in the beam, and since only a part of the focal spot produces used X-rays, thus leading to a shortened optical focal spot, the power density on the filter is reduced for the respective position. On the right side next to the top view of the rotating anode 10, a graph 128 indicates the scattered electron impact power density on the filter segment 44. The scattered electrons impinging the filter are indicated in the top view with a fan-like structure 130.

The reduced focal spot size in the second focal spot portion, in which the filter is applied, leads to an improved heat balance of the filter.

FIG. 11 shows some further aspects in relation with the filter segment 44. Three arrows 132 schematically indicate electrons of an electron beam, generating X-rays in a main depth of 5 to 20 μm. Soft X-rays 134 are passing only a short distance in the target material, approximately 30 μmW. Hard X-rays 136 are passing a long distance in the target material, approximately 100 μmW, before making before making their escape at shadow angle near the anode shadow. The soft X-rays 134 are then filtered by the filter segment 44 resulting in hardened X-rays 136′, with a smoothened beam hardening profile. In the upper right part of FIG. 11, a magnification of the filter segment 44 is provided.

As can be seen in the magnification, the filter segment 44 can be mounted in a recess 138 of the anode body 12. A gap 140 may be provided between the inner side 142 of the filter 44 and the recess wall 144 of the anode body 12. The filter 44 may be provided as a multilayer filter, for example with low-Z material 148 to prevent generation of off focal X-rays from electrons, which are backscattered of the focal spot. These electrons are indicated with dotted arrow 146. As a next layer, a main filter 150 is provided, for example 0.35 mm Mo-layer, covered by a low-Z support structure. As a next layer, a core structure 152 is provided, for example CFC. Next, a gradient filter layer 154 for beam hardening compensation is provided. On the top side, a melting preventer cap 156 may be provided, for example made from W, Mo, Ta, etc. The gradient filter layer 154 may be provided with a value of 100 μmW in the upper part and with 10 μmW in the lower part, i.e. in the part adjacent to the anode disc body 12.

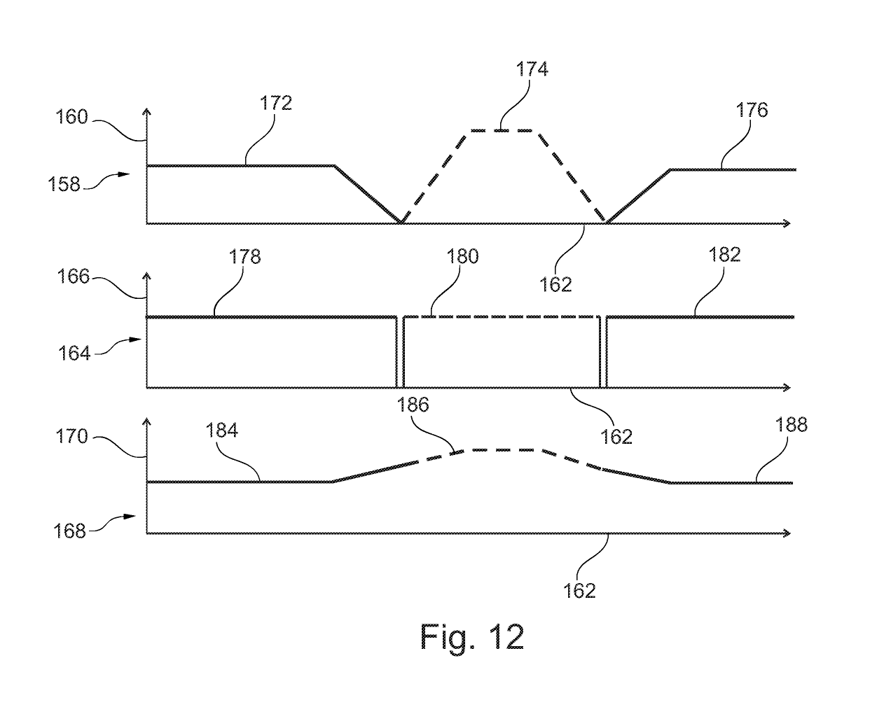

FIG. 12 schematically illustrates timing aspects, wherein a first graph 158 indicates a beam flux 160 in relation with time 162 on the horizontal line.

A second graph 164 indicates the fan coverage in all directions, indicated on the vertical line 166, across the time 162.

A third graph 168 indicates tube voltage 170 across the time 162. A first portion 172 of the first graph 158 is shown with a first line, a second portion 174 with a second line, and a third line indicates a third portion 176.

Similar line patterns are used also in the second graph 164 for a first portion 178, a second portion 180, and a third portion 182.

Accordingly, also a first portion 184, a second portion 186, and a third portion 188 are indicated with the respective line patterns in the third graph 168.

The first portions 172, 178, 184 relate to the second focal track portions 20, the second portions 174, 180, 186 relate to the first focal track portions 18, and the third portions 176, 182, 188 again relate to the second focal track portions 20.

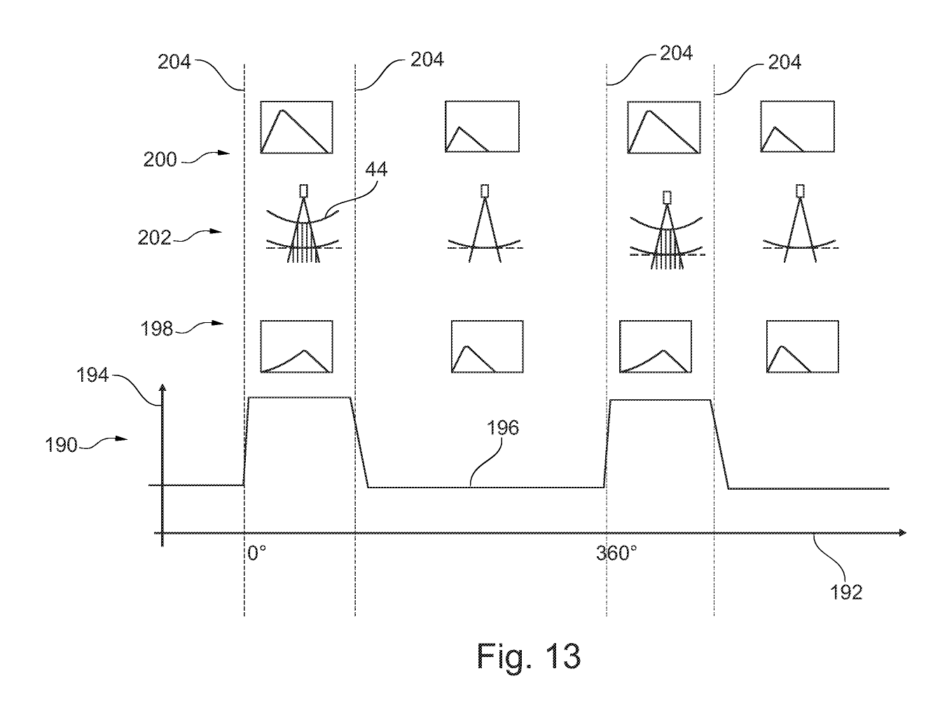

FIG. 13 illustrates aspects in relation with spectra and photon flux for an example of an anode with one filter segment. A graph 190 is shown, indicating anode rotation phase on a horizontal line 192, and a high voltage on a vertical line 194. The graph 190 shows a first curve 196 which has repeated segments after a full rotation phase, indicated with 0 degrees and 360 degrees.

Above the curve 196, simplified graphs 198 indicate the respective used beam behind the filter. In the top row, simplified graphs 200 indicate the primary beam, i.e. the beam before the filter.

In between, i.e. in the second row so-to-speak, further simplified images 202 illustrate the anode phase, i.e. the position of the filter and the respective focal track portion.

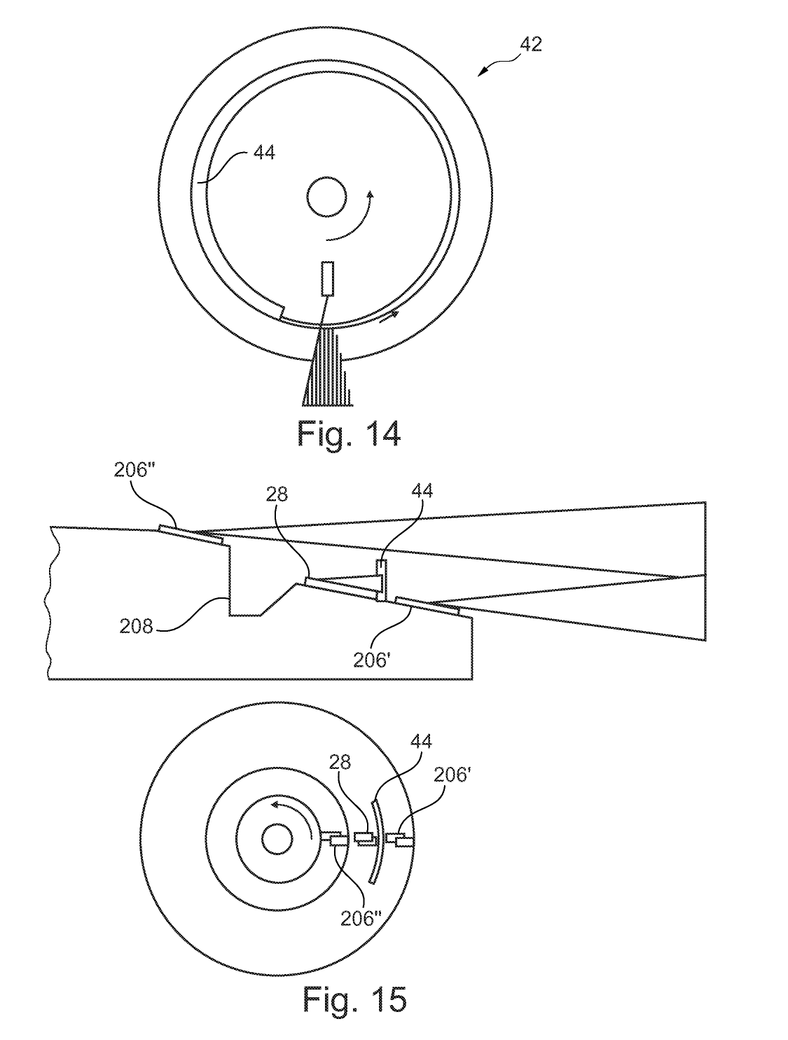

Following the value of 0 degrees of the anode rotation phase, the portion with dFlux/dE max. h/v is indicated with dotted separation lines 204. This is followed by dFlux/dE min. h/v until 360 degrees anode rotation phase. As shown in FIG. 14, the filter 42 may be provided with varying X-ray characteristic over its circumferential extension.

It is noted that FIG. 14 shows a continuous filter segment as an example only. Of course, several filter segments with varying filter X-ray characteristic each can be provided.

For example, the filter has a varying thickness over its circumferential extension.

The filter may also have a varying material composition over its circumferential extension.

The filter may also have a varying material composition over its radial extension, thus leading to varying filter X-ray characteristic.

The material of the most inner part of the filter has a relatively low atomic number, for example.

For example, the phase of pulse determines the selected filter thickness. In the example shown in FIG. 14, a thin filter is active.

According to a further example, as shown in FIG. 15 in a cross-section and top view, a further focal track 206 may be provided, which is located such that continuously unfiltered X-rays are generatable.

FIG. 15 shows two different embodiments, although in one figure. For example, the further track is provided outside the X-ray filter, as indicated with reference numeral 206′. The further track may also be provided on an elevated portion 208 of the anode inside the focal track 14, as indicated with reference numeral 206″.

Of course, the two different examples can be provided independently.

According to a further example, both examples are combined, for example by providing a portion of the outer further focal track 206′, and a further portion of the filter focal track 206″ inside the focal track 14.

FIG. 15 also indicates the filter segment 44 and the primary sub-portion 28 for illustrational purposes.

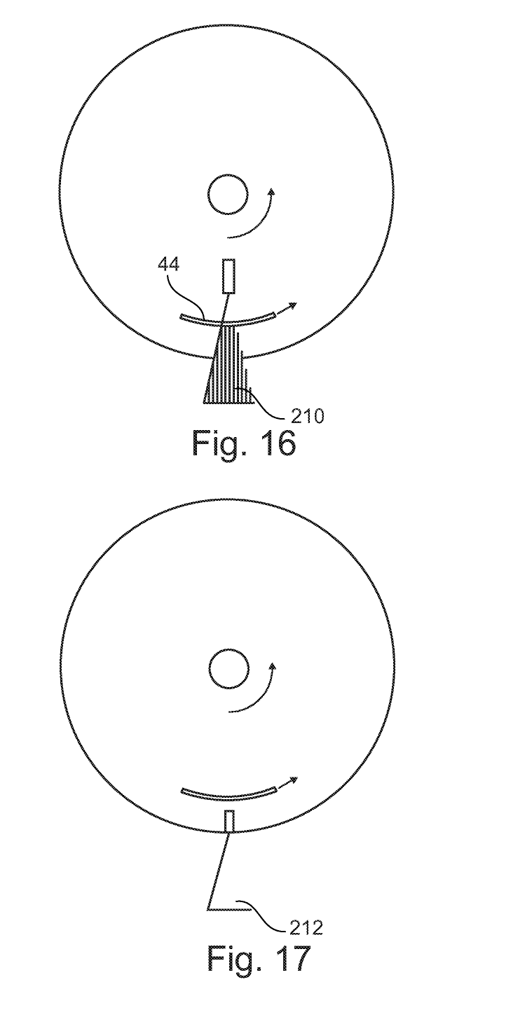

FIG. 16 shows a generation of hard X-rays 210 by the focal spot being provided on the inner tracks, i.e. in FIG. 16 on the second focal track portions 20 with a filtering effect by the filter segment 44.

Due to the dual track embodiment explained in FIG. 15, one track can be used, for example for dual energy computer tomography, and the other focal track, for example the outer focal track 206′ or the inner and elevated focal track 206″, can be used for single energy computer tomography, as shown in FIG. 17, where the focal spot is on the outermost track, and no filter is applied. This can be used, for example, for standard mode of operation. As a result, a non-filtered X-ray beam 212 is provided.

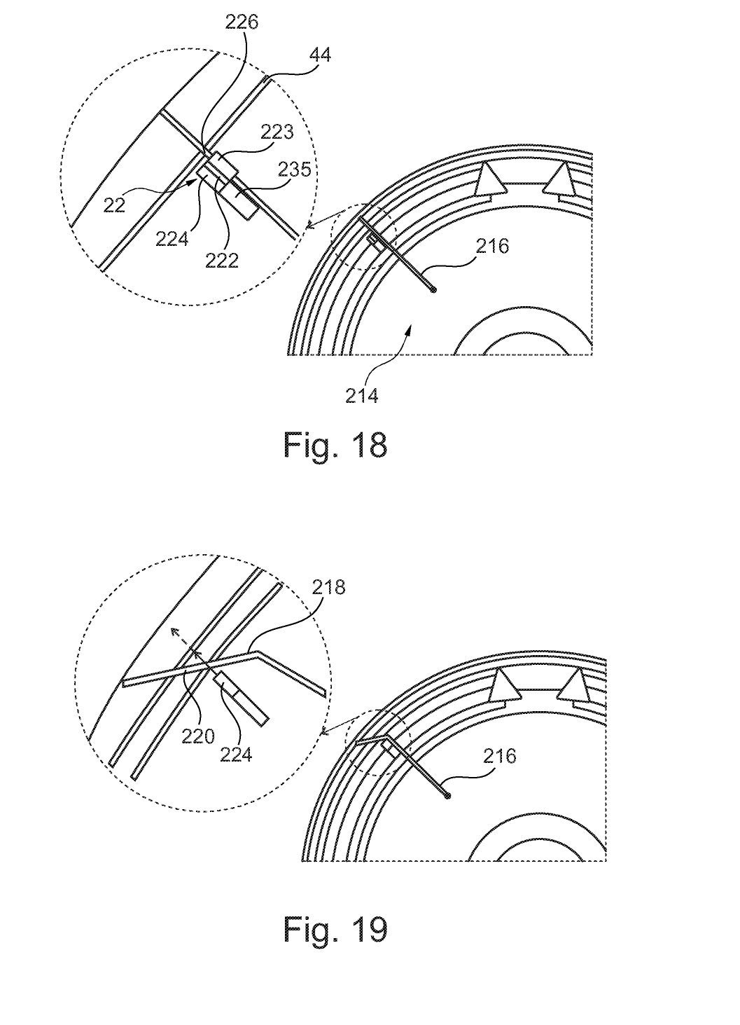

According to a further example, described in relation with FIGS. 18 and 19 for different embodiments, the anode body is provided as a segmented anode 214, comprising a number of radial slits 216 between the segments, wherein the slits may be angulated as indicated with angulated line 218 in FIG. 19 with respect to the radial direction at least in the area of the filter. The filter may also comprise slits 220 angulated with respect to the radial direction, which slits are aligned with the slits 216 in the anode body.

According to a further example, shown in FIG. 18, the beam dumps, or transition portions 22, are aligned with the slits, the slits being straight radial or inclined as mentioned above.

FIG. 18 shows a further example of beam dump. Reference numeral 22 indicates the beam dump around the slit. The further frame 224 indicates a focal spot part, which is generating X-rays. The filter 44 is also provided with a slit 226, which is also provided for the anode disc.

FIG. 19 shows the focal spot 224, which is provided, in accordance to the above-mentioned position of the focal spot, in the second focal track portion 20.

To prevent direct X-ray passage through the slit in the filter, which slit in the filter is necessary to be in accordance with the underlying slit in the underlying anode disc body, the slit runs through the filter, which may be provided as a multiple filter layer or a single filter layer, or through filter particles embedded in X-ray transparent matrix, in an inclined manner. Thus, no direct passage of X-rays through the slit is possible.

The prevention of direct X-ray passage through the slit in the filter is achieved in FIG. 18 by the slit running through the rectangular beam dump in the area of the focal track. X-rays which emerge from the bottom of the beam dump cannot enter the used X-ray beam (the aperture is properly adjusted therefore). The used X-ray beam is blanked out during passage of the slit.

The beam dump part for an electron beam is indicated with a first frame 223 and a second frame 225.

Alternatively, the beam can be switched off by a grid switch or high voltage switching. Of course, this can also be used in addition the above-mentioned examples.

As mentioned above, the anode according to the invention may be used for dual energy as an example of multiple energy X-ray radiation. Of course, also three or more energies can be provided for multiple energy X-ray radiation, thus requiring a respective adaption of the number of different focal track portions and the respective filter provision.

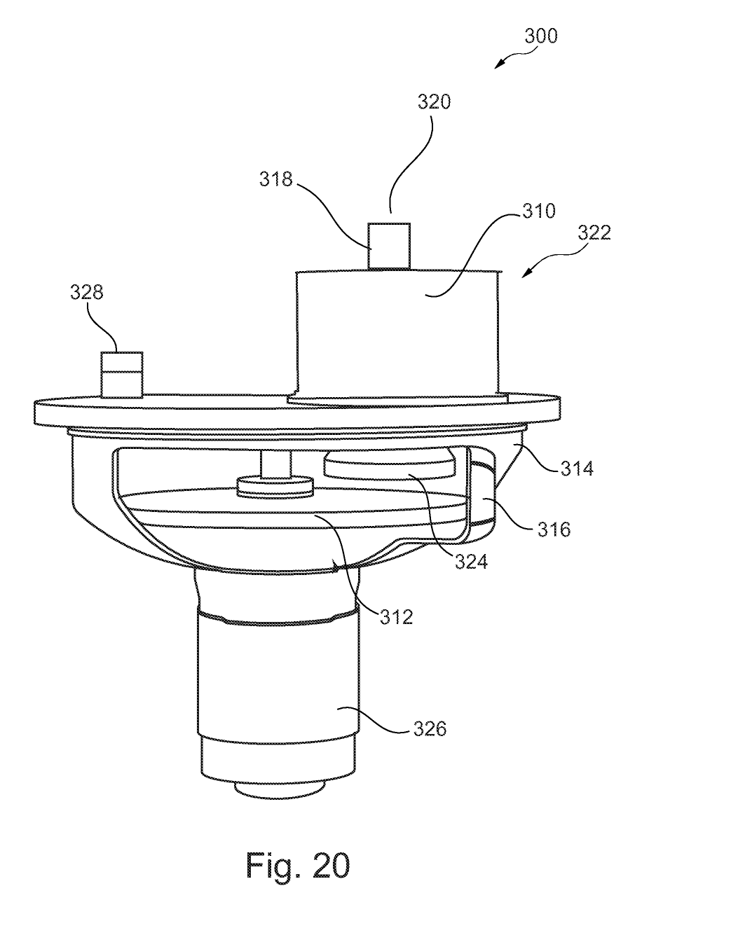

FIG. 20 shows an X-ray tube 300 for generating multiple energy X-ray radiation, comprising a cathode 310, an anode 312, and a housing 314. An electron beam can be emitted from the cathode 310 towards the anode 312, wherein the cathode and the anode are arranged inside the housing 314. An X-ray window 316 is provided in the housing. The anode is provided according to one of the above-mentioned and explained embodiments and examples.

It is noted that the X-ray tube 300 of FIG. 20 shows also some further aspects, which, however, are not essential features for the X-ray tube according to the present invention as described above.

For example, the X-ray tube design may be provided with a high emissivity cathode 318 with a flat emitter.

Further, a high voltage receptacle 320 is also shown. A quadrupole unit 322 may be provided to allow flexible focal spot shaping and deflection.

Further, a scattered electron trap 324 may pull off 40% of the energy. Further, for the rotation of the anode, a rotation system 326 is provided. Still further, a combined cooling circuit 328 for tube and generator may be provided, thus achieving high cooling efficiency.

The tube may be provided with unipolar design, leading to highest power density and a grounded anode.

For example, the X-ray tube may be designed to withstand gravitational forces up to 160 G, wherein the tube may be used for 32 G.

Further, a lead-free shielding may be provided, leading to an eco-friendly design. Further, half the mass of other CT tubes may thus be achieved.

According to an aspect of the present invention, by providing different focal track portions, a smart focal spot arrangement is provided.

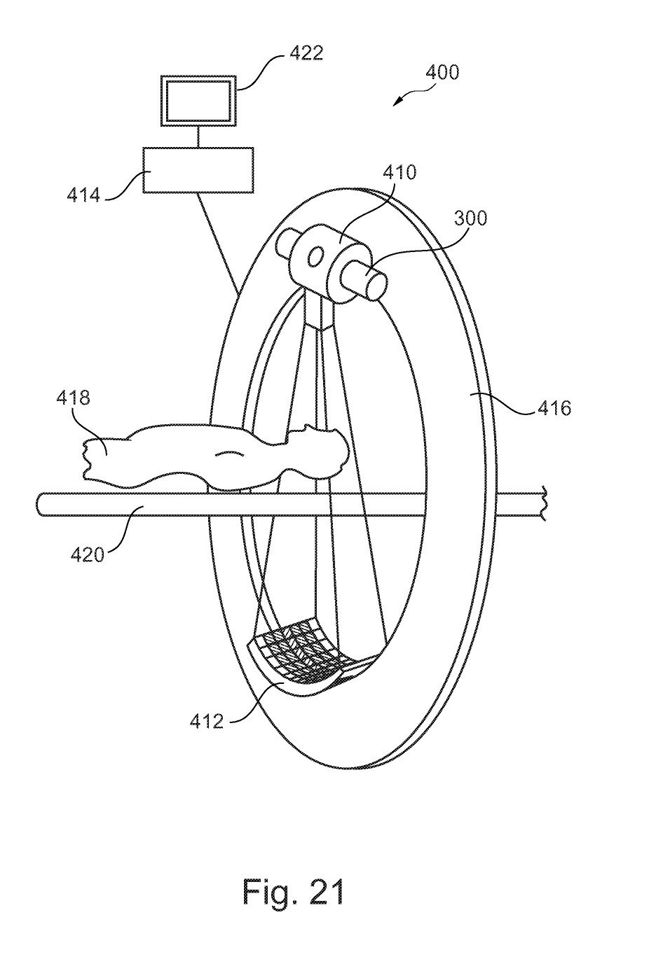

FIG. 21 shows a system 400 for X-ray imaging, comprising an X-ray source 410, an X-ray detector 412, and a control unit 414. The X-ray source 410 comprises an X-ray tube 300 according to the above-mentioned embodiments and examples. The system 400 is shown as a CT system with a gantry 416 as an example only. Further, for examination of a patient 418, a table 420 is shown to support the patient 418 during examination. Still further, a display 422 may be provided in the vicinity in order to display information. It is noted that the system is shown as an exemplary embodiment only for a CT system. However, other systems for X-ray imaging are also provided (not further shown).

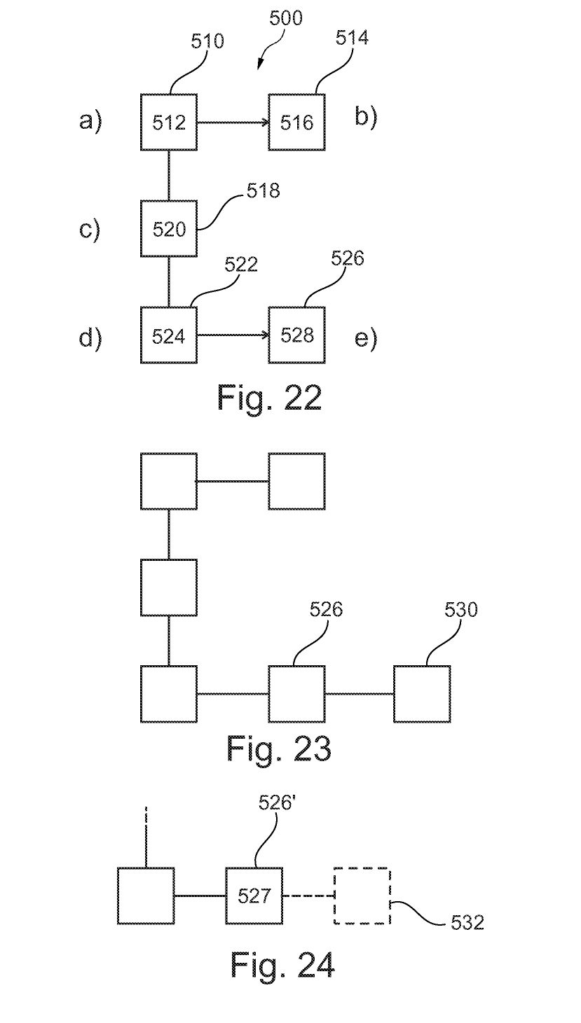

FIG. 22 shows an example of a method 500 for generating multiple energy X-ray radiation, comprising the following steps: In a first provision step 510, an electron beam is provided to a first focal track portion 512 of a rotating anode, which first focal track portion is inclined towards an X-ray radiation projection direction of the X-ray tube. In a first generation step 514, a first X-ray beam 516 with first X-ray characteristic is generated. In a second provision step 518, the electron beam is provided to a transition portion 520 between the first focal track portion and a second focal track portion, which transition portion is provided such that a direction of X-ray radiation generated at the surface of the transition portion is different than the X-ray radiation projection direction. In a third provision step 522, the electron beam is provided to the second focal track portion 524 of the rotating anode; which second focal track portion is divided in a direction transverse to the radial direction and comprises a primary sub-portion, which is inclined towards the X-ray radiation projection direction, and a secondary sub-portion, which faces less towards the X-ray radiation projection direction than the primary sub-portions. In a second generation step 526, a second X-ray beam 528 with second X-ray characteristic is generated.

The first provision step 512 is also referred to as step a), the first generating step 514 as step b), the second provision step 518 as step c), the third provision step 522 as step d), and the second generation step 526 as step e).

The second X-ray beam may be filtered in a filtering step 530 by an X-ray filter provided outside the primary sub-portion, which filter is attached to the anode. The filtering is shown in FIG. 23.

According to a further example, shown in FIG. 24, the electron beam impinging on the second focal track portion can be generated in a further generation step 526′ with a higher tube voltage 527 than an electron beam impinging on the first focal track portion. As indicated with a dotted line and a dotted frame 532, the filtering 530 can also be applied in addition to the higher tube voltage.

The anode according to the present invention provides the benefit that no extra rotating filter trays are needed, which means a cost-effective solution. Further, the anode according to the present invention also fits into existing CT gantries. Further, short transition time is provided, for example approximately 10 μs blank-out, and the X-ray flux is just reduced for a fraction of the IP. Full detector coverage is provided throughout the operation, which may be low partial shadowing, and where no penumbra occurs. Thus, high beam power at low tube voltage is provided. Further, enhanced Z-resolution at high tube voltage is possible. A further benefit lies in the fact that no grid switch is necessary. The centre position of the focal spot may be unchanged, which means an easy calibration and the use of a bowtie filter is not necessary. Further, the thermal management is also improved, and also segmented anodes are possible with the above-mentioned exemplary embodiments.

According to a further aspect, a synchronization of the anode rotation with a gantry clock is provided.

According to a further aspect of the invention, multiple concentric filter arrangements are provided to vary filter strength and material.

Further, a motor control to synchronize the anode rotation with a gantry clock (as indicated above) is provided.

The synchronization mark can be X-ray output, for example by an auxiliary detector, which is sensitive for beam intersection by beam dumps or slits.

The low-Z surface coverage of the filter (diamante, amorphous C, Be) on the side which is hit by scattered electrons is provided to avoid generation of off-focal radiation from scattered electrons.

The additional gradient filter layers are provided to compensate for heel effect (beam hardening and attenuation).

To minimize beam hardening for operation at low tube voltage, the anode angle may be larger in the low filter section, compared to the filter section, for example 10 degrees for 80 kV, 6 degrees for 140 kV, or further elongated for 80 kV focal spot.

The low filter section can also be operated on dual energy mode by alternating the high voltage levels during beam generation. According to the present invention, the tube can also be operated without alternating the tube voltage, thus providing a mixed X-ray spectrum, i.e. filtered and non-filtered, even for periods longer than the period of an anode rotation. For example, this can be provided for sampling of images with maximum tube voltage for minimum tube voltage or intermediate tube voltages over more than one rotation of the anode.

Variation of the anode rotation frequency is also possible to adapt for various pulse length requirements.

The recess at the inner edge of the filter shields direct heat flow from the focal spot (close to anode surface) and thermally couples the filter to cooler and deeper parts of the anode.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A rotating anode for an X-ray tube, comprising:
an anode body;
a circular focal track; and
an axis of rotation;
wherein the focal track is provided on the anode body and comprises at least one first focal track portion and at least one second focal track portion;
wherein transition portions are provided between the at least one first and second focal track portions;
wherein the at least one first focal track portion is inclined towards an X-ray radiation projection direction of the X-ray tube;
wherein the at least one second focal track portion is divided in a direction transverse to the radial direction and comprises a primary sub-portion, which is inclined towards the X-ray radiation projection direction, and a secondary sub-portion, which faces less towards the X-ray radiation projection direction than the primary sub-portion; and
wherein the transition portions are provided such that a direction of X-ray radiation generated at the surface of the transition portions is different from the X-ray radiation projection direction.

2. Anode according to claim 1, wherein the X-ray radiation projection direction is perpendicular to the axis of rotation;
wherein the at least one first focal track portion is inclined such that it faces away from the axis of rotation;
wherein the primary sub-portion is inclined such that it faces away from the axis of rotation; and wherein the secondary sub-portion is inclined such that it faces towards the axis of rotation; and
wherein the transition portions are facing towards the axis of rotation or are parallel to the axis of rotation and are arranged such that the surface is shielded from the X-ray radiation projection direction.

3. Anode according to claim 1, wherein the transition portions are provided with side edges adjacent to the first and second focal track portions; wherein the side edges are tapered in a direction away from the axis of rotation.

4. Anode according to claim 1, wherein an X-ray filter with at least one X-ray filter segment is provided outside the primary sub-portion of the at least one second focal track portion, which filter segment is attached to the anode.

5. Anode according to claim 1, wherein a further focal track is provided, which is located such that continuously unfiltered X-rays are generatable.

6. Anode according to claim 1, wherein the anode body is provided as a segmented anode comprising a number of radial slits between the segments; wherein the slits are angulated with respect to the radial direction at least in the area of the filter; and wherein the filter comprises slits angulated with respect to the radial direction; which slits are aligned with the slits in the anode body.

7. Anode according to claim 1, wherein the filter has a varying filter X-ray characteristic over its circumferential extension.

8. An X-ray tube for generating multiple energy X-ray radiation, comprising:
a cathode;
an anode; and
a housing;
wherein an electron beam can be emitted from the cathode towards the anode;
wherein the cathode and the anode are arranged inside the housing;
wherein an X-ray window is provided in the housing; and
wherein the anode is provided according to claim 1.

9. X-ray tube according to claim 8, wherein deflection means are provided to deflect the electron beam to different positions on the anode.

10. A system for X-ray imaging, comprising:
an X-ray source;
an X-ray detector; and
a control unit;
wherein the X-ray source comprises an X-ray tube according to claim 8.

11. A method for generating multiple energy X-ray radiation, comprising the following steps:
a) providing an electron beam to a first focal track portion of a rotating anode; which first focal track portion is inclined towards an X-ray radiation projection direction of the X-ray tube;
b) generating a first X-ray beam with first X-ray characteristic;
c) providing the electron beam to a transition portion between the first focal track portion and a second focal track portion, which transition portion is provided such that a direction of X-ray radiation generated at the surface of the transition portion is different than the X-ray radiation projection direction;
d) providing the electron beam to the second focal track portion of the rotating anode; which second focal track portion is divided in a direction transverse to the radial direction and comprises a primary sub-portion, which is inclined towards the X-ray radiation projection direction, and a secondary sub-portion, which faces less towards the X-ray radiation projection direction than the primary sub-portion; and
e) generating a second X-ray beam with second X-ray characteristic.

12. Method according to claim 11, wherein the second X-ray beam is filtered by an X-ray filter provided outside the primary sub-portion, which filter is attached to the anode.

13. Method according to claim 11, wherein the electron beam impinging on the second focal track portion is generated with a higher tube voltage than an electron beam impinging on the first focal track portion.

14. A computer program element for controlling an apparatus according to claim 1.

15. A computer readable medium having stored the program element of claim 14.
